(19) United States
(12) Patent Application Publication
(10) Pub. No.: US 2023/0084865 A1
(43) Pub. Date: Mar. 16, 2023

(54) METHOD AND APPARATUS FOR DETERMINING SIGNAL SAMPLING QUALITY, ELECTRONIC DEVICE AND STORAGE MEDIUM

(71) Applicant: Beijing Baidu Netcom Science Technology Co., Ltd., Beijing (CN)

(72) Inventor: Zelin MENG, Beijing (CN)

(21) Appl. No.: 17/939,367

(22) Filed: Sep. 7, 2022

(30) Foreign Application Priority Data
Mar. 31, 2022 (CN) 202210345361.4

(51) Int. Cl. G06K 9/62; G06N 10/20

(52) U.S. Cl. CPC G06K 9/6262; G06K 9/6232; G06K 9/6269; G06N 10/20

(57) ABSTRACT

A method, an electronic device, an apparatus, and a storage medium for determining a signal sampling quality are provided. The method includes sampling a first output signal of a quantum chip based on a first sampling parameter to obtain first sampled data; performing feature extraction on the first sampled data to obtain a first feature extraction result; and clustering the first feature extraction result to determine a sampling quality classification result.

### CROSS-REFERENCE TO RELATED APPLICATIONS

The present application claims the priority of Chinese Patent Application No. 202210345361.4, titled “METHOD AND APPARATUS FOR DETERMINING SIGNAL SAMPLING QUALITY, ELECTRONIC DEVICE AND STORAGE MEDIUM”, filed on Mar. 31, 2022, the content of which is incorporated herein by reference in its entirety.

### TECHNICAL FIELD

The present disclosure relates to the field of quantum computation, in particular to the field of quantum signals, specifically, to a method and apparatus for determining a signal sampling quality, an electronic device and a storage medium.

### BACKGROUND

In order to realize a quantum gate on a quantum chip with a relative high precision, an experimenter needs to precisely calibrate a control pulse of each quantum bit on the quantum chip by repeatedly inputting a certain control pulse into the quantum chip and reading the same, updating pulse parameters after calculation and analysis, and repeatedly performing iteration and outputting the optimized control pulse parameters finally. However, with the increase of human demands and a progress of a quantum chip process, the number of quantum bits integrated on the quantum chip rapidly increases, so that a lot of time and labor are required in a process of determining optimal pulse parameters, and a working efficiency is reduced.

### SUMMARY

The present disclosure provides a method and apparatus for determining a signal sampling quality, electronic device and storage medium.

Some embodiments of the present disclosure provide a method of determining a signal sampling quality, including: sampling a first output signal of a quantum chip based on a first sampling parameter to obtain first sampled data; performing feature extraction on the first sampled data to obtain a first feature extraction result; and clustering the first feature extraction result to determine a sampling quality classification result.

Some embodiments of the present disclosure provide a method for training a sampling quality classification model, including: sampling a plurality of second output signals of a quantum chip respectively based on a plurality of second sampling parameters to obtain a plurality of sets of second sampled data; performing feature extraction on each of the plurality of sets of second sampled data to obtain a plurality of second feature extraction results, each corresponding to a set of second sampled data; and training a clustering model using the plurality of second feature extraction results to obtain a sampling quality classification model, wherein the sampling quality classification model is configured to determine a sampling quality classification result.

Some embodiments of the present disclosure provide a apparatus for determining a signal sampling quality, including: a first sampling module, configured to sample a first output signal of a quantum chip based on a first sampling parameter to obtain first sampled data; a first extraction module, configured to perform feature extraction on the first sampled data to obtain a first feature extraction result; and a classification module, configured to cluster the first feature extraction result to determine a sampling quality classification result.

Some embodiments of the present disclosure provide a apparatus for training a sample quality classification model, including: a second sampling module, configured to sampling a plurality of second output signals of a quantum chip respectively based on a plurality of second sampling parameters to obtain a plurality of sets of second sampled data; a second extraction module, configured to perform feature extraction on each of the plurality of sets of second sampled data to obtain a plurality of second feature extraction results, each corresponding to a set of second sampled data; and a training module, configured to train a clustering model using the plurality of second feature extraction results to obtain a sampling quality classification model, wherein the sampling quality classification model is configured to determine a sampling quality classification result.

Some embodiments of the present disclosure provide an electronic device, including:

at least one processor; and

a memory communicatively connected to the at least one processor; wherein,

the memory stores instructions executable by the at least one processor, and the instructions, when executed by the at least one processor, cause the at least one processor to perform the above method.

Some embodiments of the present disclosure provide a non-transitory computer readable storage medium storing computer instructions is provided, wherein, the computer instructions are used to cause the computer to perform the above method.

Some embodiments of the present disclosure provide a computer program product, including a computer program/instruction, the computer program/instruction, when executed by a processor, implements the above method.

It should be understood that contents described in this section are neither intended to identify key or important features of embodiments of the present disclosure, nor intended to limit the scope of the present disclosure. Other features of the present disclosure will become readily understood in conjunction with the following description.

### BRIEF DESCRIPTION OF THE DRAWINGS

The accompanying drawings are used for better understanding of the present solution, and do not constitute a limitation to the present disclosure. In which:

FIG. 1 is a schematic flowchart of a method for determining a signal sampling quality according to an embodiment of the present disclosure;

FIG. 2 is a schematic flowchart of a method for determining a signal sampling quality according to another embodiment of the present disclosure;

FIG. 3 is a schematic diagram of a Rabi oscillation curve and a fitting result thereof according to an embodiment of the present disclosure;

FIG. 4 is a schematic flowchart of a method for determining a signal sampling quality according to still another embodiment of the present disclosure;

FIG. 5 is a flow diagram of a method for training a sampling quality classification model according to an embodiment of the present disclosure;

FIG. 6 is a schematic diagram of a sampled data classification result according to an embodiment of the present disclosure;

FIG. 7 is a schematic diagram of training steps of a sampling quality classification model according to an embodiment of the present disclosure;

FIG. 8 is a schematic diagram of applying steps of a sampling quality classification model according to an embodiment of the present disclosure;

FIG. 9 is a schematic diagram of steps for correcting a sampled signal according to an embodiment of the present disclosure;

FIG. 10 is a schematic structural diagram of an apparatus for determining a signal sampling quality according to an embodiment of the present disclosure;

FIG. 11 is a schematic structural diagram of an apparatus for determining a signal sampling quality according to another embodiment of the present disclosure;

FIG. 12 is a schematic structural diagram of an apparatus for determining a signal sampling quality according to still another embodiment of the present disclosure;

FIG. 13 is a schematic structural diagram of an apparatus for training a sampling quality classification model according to an embodiment of the present disclosure;

FIG. 14 is a block diagram of an electronic device for implementing a method of determining a signal sampling quality of an embodiment of the present disclosure.

### DETAILED DESCRIPTION OF EMBODIMENTS

Exemplary embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described here without departing from the scope and spirit of the present disclosure. Similarly, for clearness and conciseness, descriptions of well-known functions and structures are omitted in the following description.

The term “and/or,” as used herein, is merely an association relationship that describes associated objects, meaning that there may be three relationships. For example, A and/or B may refer to: only A, A and B, and only B. The term “at least one” refers herein to any one of multiple elements or a combination of at least two of multiple elements. For example, by including at least one of A, B, C, may refer to any one or more elements selected from the group consisting of A, B, and C. The terms “first” and “second” are used herein to refer to and distinguish between a plurality of similar terms, and are not intended to limit the meaning of a sequence, or to limit the meaning of only two, e.g., a first feature and a second feature refer to two categories/features, the first feature may be one or more, and the second feature may be one or more.

In addition, numerous specific details are set forth in the following detailed description in order to better illustrate the disclosure. It will be understood by those skilled in the art that the present disclosure may be implemented without certain specific details. In some instances, methods, means, elements, and circuits well known to those skilled in the art have not been described in detail in order to highlight the spirit of the present disclosure.

Quantum computing is a computational model that follows quantum mechanics and regulates quantum information units to perform calculations. Compared to conventional computers, quantum computing is superior to conventional general-purpose computers in dealing with certain problems. In quantum computing, a quantum gate can convert a certain quantum state into another quantum state, which is a reversible basic operation unit, and preparing a high-fidelity quantum gate by designing pulses has always been a key problem in experiments. In order to realize the quantum gate with a relatively high precision, an experimenter needs to precisely calibrate a control pulse of each quantum bit (i.e., a basic unit for constituting the quantum gate) on the quantum chip by repeatedly inputting a certain control pulse into the quantum chip and reading the same, updating pulse parameters after calculation and analysis, and repeatedly performing iterations and outputting the optimized control pulse parameters finally. However, with the increase of human demands and the progress of a quantum chip process, the number of quantum bits integrated on the quantum chip rapidly increases, so that a lot of time and labor are required to perform the calibration of the quantum chip (i.e., finding the optimized control pulse parameters), and the working efficiency is reduced.

In conventional quantum computer laboratories, a calibration process is often performed manually or by a semi-automatic program. For a manual calibration, the experimenter is required to manually set a calibration pulse and analyze the read result manually. For a calibration using the semi-automatic program, the program can automatically set a calibration pulse according to a preset parameter range and analyze data, and meanwhile, an algorithm (such as numerical optimization or multi-dimensional scanning) can be added to accelerate the calibration process. In particular, a manual calibration solution or a calibration solution using the semi-automatic program is specifically described as follows.

(1) Traditional Manual Calibration Method

In this type of method, the experimenter needs to set a control pulse needed for a calibrate experiment and analyze the returned data. If scanning parameters are not properly selected, the experimenter needs to determine a reason according to experience and adjust a parameter range and re-set the experiment.

However, this method is highly dependent on the experimenter and requires higher experience in experiments. An expansibility of the traditional method is also poor, and with the increase of the number of quantum bits and the increase of a complexity of coupling structures, calibration work will also be significantly increased.

(2) Semi-Automatic Calibration Method: A Calibration Method Based on an Optimization Algorithm

According to an existing technical solution, physical bits are grouped and independently optimized according to a topology structure and a connectivity of a chip, so that a dimension reduction of a high-dimensional parameter space in an optimization process is realized, and a time complexity in optimization is reduced. In related technologies, the solution is applied to a quantum chip with 54 quantum bits to achieve a |0 [symbol] state error rate of 0.97% and a median |1 [symbol] state error rate of 4.5%.

In addition, there is a semi-automatic calibration method called “autoRabi algorithm”, which defines a multi-dimensional optimization process, and optimizes bit reading, a Rabi oscillation experimental result (including a period, a population distribution, etc) simultaneously. Its loss function is defined as Lₜₒₜ=L_{F}+L_{AC}+L_{T}+L_{BIC}, where L_{F} is used to describe the fitting, L_{AC} is used to describe the population distribution, L_{T} is used to ensure that a maximum slope of a rising edge of a pulse is in a specified range, and L_{BIC} is used to ensure that there are only two clusters on an IQ plane of a readout signal. Finally, an error rate of the order of 10⁻⁴ is achieved on a simulator by the “autoRabi algorithm”.

However, in general, the calibration method based on the optimization algorithm strongly depends on a selection of initial parameters, and if the initial parameters largely differs from target parameters, it is very likely to fall into a local optimal solution with a large error, resulting in a less ideal optimization effect. Meanwhile, this method needs to adjust program settings (such as the optimization algorithm, a search strategy, or a loss function) according to actual situations of equipments and chips, so that the expansibility is poor. Moreover, since an exception handling capability is not available, it is difficult to achieve a complete automation.

(3) Semi-Automatic Calibration Solution: A Calibration Method Based on Machine Learning

In the related technologies, there is a method based on ablation study in machine learning, the core idea of which is to perform a plurality of directional one-dimensional searches for a high-dimensional parameter space, so as to depict a hyper-surface in which an optimal value is located. Redundant search space is removed through an algorithms using the ablation study. A speed of the above-mentioned method is increased by about 180 times compared with that of a method in which randomly searching optimal parameters is performed.

In the related technologies, there is also a solution for predicting a classification to which a data sample belongs using a convolutional neural network. This solution can obtain a probability vector [symbol] =[p_{A},p_{B}, . . . ]^{T} to describe a probability of a current sample belonging to each classification (A, B, . . . ), and optimize parameter scanning by constructing a loss function based on the vector. This method achieves a recognition accuracy of 88.5%. In the related technologies, reinforcement learning is also used to solve a problem in quantum state manipulation, and is combined with some common-used methods, thus improving a manipulation fidelity.

However, as described above, most of the existing implementations use the machine learning to accomplish tasks, such as image classification, parameter-space dimension reduction, and quantum state preparation. It is difficult to determine a correct subsequent operation when an abnormal situation occurs, and thus it is difficult to realize a real “automation”.

In summary, however, the above mentioned manual or semi-automatic calibration algorithms depend on the selection of the initial parameters, which makes it difficult for these algorithms to completely get rid of manual intervention. At the same time, the optimization algorithm also suffers from a local optimal solution, and thus an expected result may not be obtained. The multi-dimensional scanning often requires a large amount of samplings, and thus an efficiency is lower. As the number of quantum bits integrated on the chip increases, and if a speed of calibrating the pulse is slower than that of a parameter drift, the efficiency of the quantum computer will not be adequate for a quantum task of a high precision.

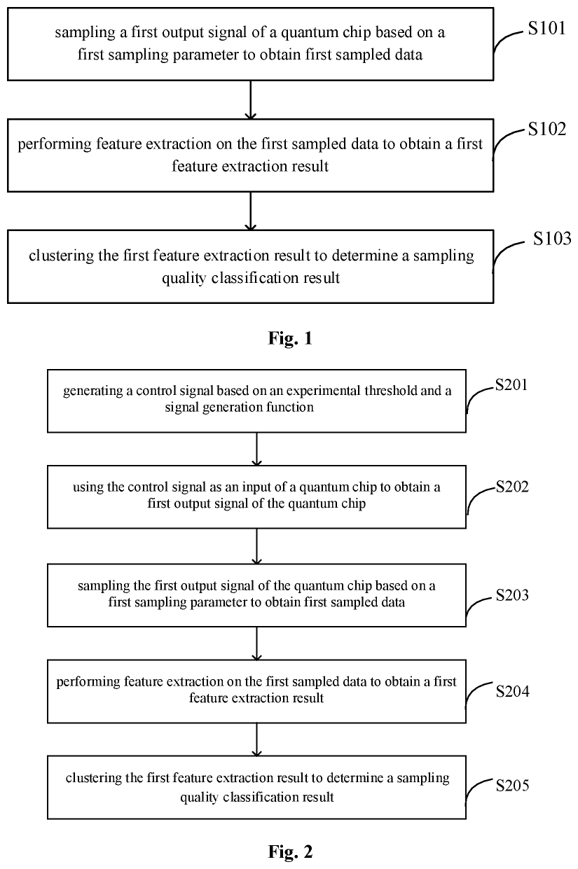

According to an embodiment of the present disclosure, a method for determining a signal sampling quality is provided, and FIG. 1 is a schematic flowchart of the method for determining a signal sampling quality according to an embodiment of the present disclosure. As shown in FIG. 1, the method specifically includes S101 to S103.

S101: sampling a first output signal of a quantum chip based on a first sampling parameter to obtain first sampled data.

In an example, an experimental pulse is constructed through a preset experimental flow and a preset sampling parameter, and a control signal is generated and input to the quantum chip located in a refrigerator to generate the output signal (also called a return signal). A state of the quantum chip cannot be directly acquired, and can only obtained by the by a reading device to sample and analyze the output signal. The first sampled data includes a plurality of samples with different amplitudes, and the sample parameter may include an amplitude scanning interval and a number S of sample points within the interval. After the sampling is completed, “the first sampled data” after the sampling contains S sample points within a whole amplitude scanning interval.

In an example, the sampled data is a “population”. Of course, other types of sampled data (such as an in-phase orthogonal signal (an IQ signal), a reflected signal, etc.) may also be acquired according to actual situations.

S102: performing feature extraction on the first sampled data to obtain a first feature extraction result.

In an example, fitting parameters are selected to fit the first sampled data, and then a plurality of types of eigenvalues are extracted according to features of the first sampled data in combination with the fitted curve to obtain the first feature extraction result. Optional feature value types include: a “fitting function”, a “co-correlation coefficient”, a “population distribution”, an “oscillation period”, and the like. The present disclosure is not limited herein as long as the features of the sampled data and the fitting curve can be embodied. After obtaining the plurality of types of eigenvalues, a training sample matrix is generated.

S103: clustering the first feature extraction result to determine a sampling quality classification result.

In an example, the clustering can be specifically implemented by means of a trained clustering model. That is, the first feature extraction result is input into the trained clustering model. Of course, the clustering can also be implemented by other clustering methods, which are not limited herein. The sampling quality classification result is a classification result with a sampling quality of “good” or “bad” sampling quality. The “bad” classification result are also classified into various specific “bad” types, including: oversampling, undersampling, the amplitude scanning interval of sampling being too small, the amplitude scanning interval of sampling being too large, and the like.

In the above-described embodiment, after the sampling is completed, any signal data and a sampling result thereof are analyzed using a clustering method to determine the sampling quality classification result of this sampling, which belongs to an “application stage”. By using this method, an automatic sampling process has a strong interpretability. A specific type of sampling can be automatically and accurately analyzed, a non-ideal sampling condition can be found in time, and subsequent processing is facilitated, such that a more complete automation is achieved, and a probability of a final successful sampling is also increased.

In an embodiment, in the step S102, performing the feature extraction on the first sampled data to obtain the first feature extraction result may include: generating a fitting function according to a signal generation function and/or a structure of the quantum chip; fitting the first sampled data using the fitting function to obtain a fitting curve; and obtaining the first feature extraction result according to the first sampled data and the fitting curve.

Specifically, a generation function of the input signal can be determined according to an actual application of the quantum chip, and the input signal of the quantum chip can be generated based on the generation function of the input signal. A plurality of sampling points of the output signal are obtained by sampling.

Further, when performing feature extraction on the sampling points, a fitting function for fitting is selected according to the generation function of the input signal and/or structural properties of the quantum chip. The fitting function may be a trigonometric function or a Gaussian function. Then, a fitting operation is performed on the sampling points using the fitting function to obtain the fitting curve.

An application example based on a superconducting experiment is described below. In the superconducting experiment, a Rabi oscillation experiment is often used. The Rabi oscillation experiment can be used to find a Rami frequency, usually related to a calibration of a single-bit gate in quantum calculations.

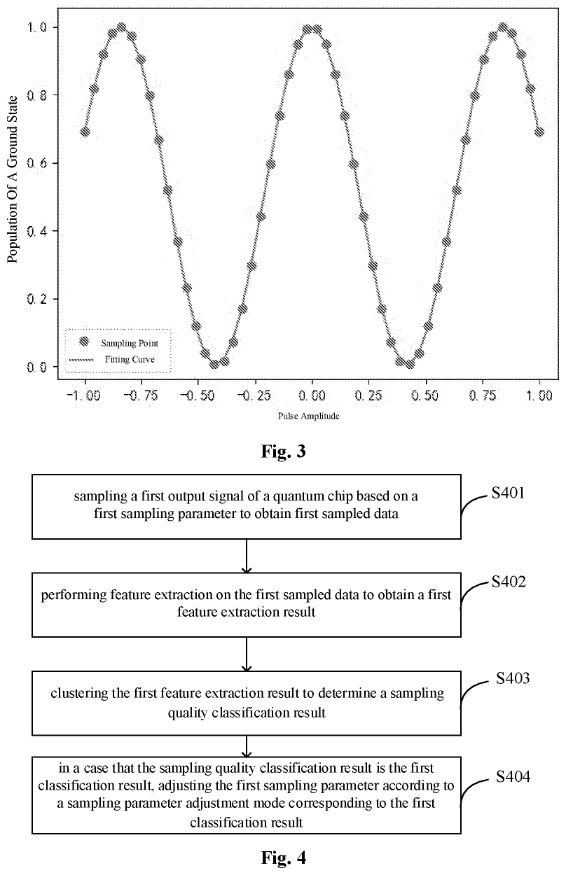

For example, a microwave drive pulse with a fixed duration is applied to a physical bit, an oscillation curve can be observed by adjusting a pulse intensity of the microwave drive pulse, and an amplitude corresponding to the first peak from the zero amplitude is taken as an amplitude of a π pulse. A typical Rabi oscillation curve and a fitting result thereof are shown in FIG. 3. Points in FIG. 3 represent the sampling points, and after the sampling points are obtained, Equation (1) can be used as the fitting function to perform fitting:

$$f ( x ) = \frac{a}{2} cos ( bx + c ) + d . \qquad ( 1 )$$

where x is the abscissa (the pulse intensity), the fitted b is related to a π pulse intensity.

Further, a related characteristic number is calculated by the features of the sampling points and the fitting curve. With the above example, a difference between the sampling data and the fitting result is applied to construct the feature. Since the fitting function is often given by known theoretical knowledge, it is possible, if the features are obtained in this way and used for subsequent clustering, to ensure that the clustering process is guided by theories, thereby accelerating the clustering process, and increasing an accuracy of the clustering result.

According to an embodiment of the present disclosure, a method for determining a signal sampling quality is provided, and FIG. 2 is a schematic flowchart of a method for determining a signal sampling quality according to another embodiment of the present disclosure. As shown in FIG. 2, the method specifically includes S201 to S205.

S201: generating a control signal based on an experimental threshold and a signal generation function;

S202: using the control signal as an input of a quantum chip to obtain a first output signal of the quantum chip.

S203, sampling the first output signal of the quantum chip based on a first sampling parameter to obtain first sampled data;

S204, performing feature extraction on the first sampled data to obtain a first feature extraction result;

S205: clustering the first feature extraction result to determine a sampling quality classification result.

Steps S203-S205 are similar or identical to steps S101-S103, respectively, and will not be repeated herein.

In an example, the control signal (also called a control pulse) is constructed by using a Gaussian function as the signal generation function, on the premise of performing calibration using Rabi experiments. In the Gaussian function, parameters may be set according to the experimental threshold, the parameters including: a maximum amplitude, a center position of the pulse, a standard deviation, etc. In experiments, it is also possible to set a plurality of signals with different amplitudes and combine them into a complex control signal by means of the signal generation function. An initial first sampling parameter may be set according to the characteristics of the control signal. The control signal is input to the quantum chip located in a refrigerator to obtain the first output signal.

In the present disclosure, a function for generating the control pulse is not limited, and the Gaussian function is a relatively common solution. In addition, also commonly used solutions include square waves, error functions, derivative removal by adiabatic gate pulses (DRAG pulses) and so on, which can be flexibly selected according to the specific needs of the experiment. The DRAG pulse can be interpreted as adiabatic-gate derivative elimination, and is a particular waveform envelope used to modify an energy-lever leakage. If an expression of a pulse required for a task itself is differentiable and is denoted as Ω(t), a first-order DRAG pulse is Δ·dΩ(t)/dt, where Δ is a to-be-determined coefficient. After determining an appropriate Δ, the DRAG pulse may be used for correcting the Ω(t) to reduce the energy level leakage.

With the above solution, it is possible to determine the signal threshold and a function for generating a signal (the signal generation function) according to experimental requirements, and to generate the control signal more accurately.

In an embodiment, the first sampled data includes populations of a quantum state at different energy levels, and the first sampling parameter includes a scanning interval and a number of sampling times. In step S101, sampling the first output signal of the quantum chip based on the first sampling parameter to obtain the first sampled data may include: sampling the first output signal of the quantum chip according to the number of sampling times in the scanning interval to obtain the populations the quantum state at different energy levels.

Specifically, the sampling parameter includes a scanning interval (also called a sampling interval) and the number of sample times within the interval. The sampling may be performed uniformly or non-uniformly within the scanning interval. Using the population as a measurement result of sampling, the population can represent the number of atoms/molecules at different (energy) levels. The population can intuitively show a classical probability distribution of each computing base of a quantum bits, and can reflect a ratio between the number of atoms in a certain state and the number of atoms in another state, which can better reflects an effect of “converting a quantum state by a quantum gate,” and can provide better reference data for the calibration of the quantum chip.

In an embodiment, the first feature extraction result may include at least one of a fitting error, a co-correlation coefficient, a sampled data feature, an autocorrelation function, and a periodic sample point feature.

Specifically, the selection of the characteristic number is related to a control/fitting function of an input/output signal, a structural feature of the quantum chip, or a property of a sampling point. For example, when the sampled data is the population, the eigenvalue of the population is used as the feature of the sampled data in the characteristic number. Specific manners of calculating each of the above characteristic numbers will be described in detail below.

By using the above example, multiple characteristic numbers which is in multiple aspects and can specifically reflect the sampling process can be obtained according to the sampling process. Based on this, a more accurate classification model can be obtained in subsequent training.

According to an embodiment of the present disclosure, there is provided a method for determining a signal sampling quality. The sampling quality classification result includes a first classification result that does not meet a preset quality standard and a second classification result that meets the preset quality standard. FIG. 4 is a flow diagram of a method for determining a signal sampling quality according to still another embodiment of the present disclosure. As shown in FIG. 4, the method specifically includes S404 to S404.

S401: sampling a first output signal of a quantum chip based on a first sampling parameter to obtain first sampled data;

S402: performing feature extraction on the first sampled data to obtain a first feature extraction result;

S403: clustering the first feature extraction result to determine a sampling quality classification result; and

S404: in a case that the sampling quality classification result is the first classification result, adjusting the first sampling parameter according to a sampling parameter adjustment mode corresponding to the first classification result.

The steps S401-S403 are similar or identical to the steps S101-S103, respectively, and will not be repeated herein.

In an example, there are a plurality of types of sampling quality classification result, such as the first classification result and the second classification result. The second classification result may be a result that meets the preset quality standard, such as “good”, “qualified” and the like. The first classification result may be a result that does not meet the preset quality standard, such as “unqualified”, “bad” and the like. Expressions of “meets the preset quality standard” and “does not meet the preset quality standard” are defined differently in different application scenarios, and are not limited herein.

There may be a plurality of first classification results, and the plurality of first classification results are classified more detailed according to specific reasons causing the classification results failing to meet the preset quality standard, and correspond to different sampling parameter adjustment modes respectively.

In an example, the sampling parameter adjustment modes may include adjusting the sampling interval and/or adjusting the number of sampling points. Specifically, adjusting the sampling interval includes enlarging the sampling interval or reducing the sampling interval, and adjusting the number of sampling points includes increasing the number of sampling points or decreasing the number of sampling points. For example, the first classification result is “oversampling” in “unqualified”, the preset sampling parameter adjustment mode is reducing the number of sampling times in a unit area by a half.

These adjustment modes well cover all the adjustment operations which can be performed corresponding to the cases in which “the sampled data does not meet the preset quality standard”. In an actual operation process, a preset adjustment mode can be selected according to the classification result, so that the parameter adjustment process is performed fast and accurately without experience of the manual operations, and the optimal sampling parameters are approximated more efficiently. A specific adjustment mode can be flexibly set according to actual conditions, and is not limited herein.

Further, in a case that the sampling quality classification result is the first classification result, that is, in a case that the sampling quality classification result does not meet the preset quality standard, the first sampling parameter can be adjusted by a sampling parameter adjustment mode corresponding to the first classification result.

After the sampling parameter is adjusted, it proceeds with performing sampling on the output signal with a new sampling parameter, and then the solution including S401-S403 is repeated to evaluate the quality of the output signal to obtain a quality classification result (an evaluation result) until the quality classification result is the second classification result, that is, the evaluation result meets the preset quality standard.

With the above-described solution, in a process of repeating trials to obtain the optimal sampling parameters, it is possible to perform the repeated trials automatically using a program instead of performing manually. This process reduces labor consumption, because the parameter are improved automatically by a current evaluation result, and the optimal sampling parameters can be approximated more efficiently.

That is, the present disclosure can implement a solution for calibrating a control pulse of the quantum chip based on abduction reasoning. Specifically, the sampling quality classification result of the sampled data, i.e. the second classification result meeting the preset quality standard or the first classification result not meeting the preset quality standard, is determined, and in a case that the sampling quality classification result is the first classification result, the sampling parameter is automatically adjusted according to a sampling parameter adjustment mode corresponding to a reason for the sampling quality classification result failing to meet the preset quality standard, so that the sampled data meeting the preset quality standard is finally obtained, thereby realizing automatic guidance of the calibration process.

In an embodiment, in step S103, clustering the first feature extraction result to determine a sampling quality classification result, may include: inputting the first feature extraction result into a sampling quality classification model to obtain the sampling quality classification result, the sampling quality classification model being obtained by training a clustering model.

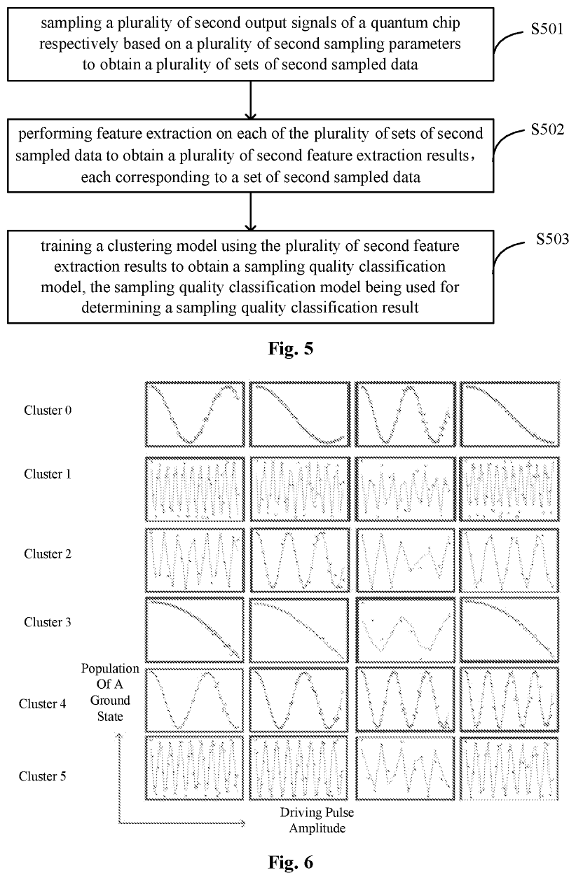

For example, the clustering model is first trained into the sampling quality classification model, and then the first feature extraction result is input into the trained sampling quality classification model to obtain a sampling quality classification result. Therefore, an efficiency of determining the sampling quality classification result can be increased, and a calibration speed can be increased. According to an embodiment of the present disclosure, a method for training the sampling quality classification model is provided, and FIG. 5 is a schematic flowchart of the method for training the sampling quality classification model according to an embodiment of the present disclosure. As shown in FIG. 5, the method may include S501 to S503.

S501: sampling a plurality of second output signals of a quantum chip based on a plurality of second sampling parameters respectively to obtain a plurality of sets of second sampled data.

In an example, the plurality of output signals are respectively sampled by using the plurality of sampling parameters, and a specific principle and sampling process are identical to those disclosed in step S101, and will not be repeated herein. That is, the above-mentioned step S501 can be regarded as performing the step S101 for a plurality of times simultaneously to obtain the plurality of sets of second sampled data.

S502: performing feature extraction on each of the plurality of sets of second sampled data respectively to obtain a plurality of second feature extraction results, each corresponding to a set of second sampled data.

In an example, feature extraction is performed respectively on the plurality of sets of second sampled data as obtained. A specific extraction process is similar or identical to the step S102, and will not be repeated herein.

S503: training a clustering model using the plurality of second feature extraction results to obtain a sampling quality classification model, the sampling quality classification model being used for determining a sampling quality classification result.

In an example, the clustering model may be a K-means algorithm clustering model. A basic idea of a clustering algorithm in machine learning is briefly introduced firstly. A core task of clustering is to attempt to divide samples in a dataset into disjoint subsets, each called a “cluster”. Each cluster corresponds to a certain possible, potential category or concept, such as “sampled data qualified”, “sampled data unqualified”, “sampled data being unqualified because of oversampling”, “sampled data being unqualified because the sampling points are too few” and the like. These concepts are unknown to the clustering algorithm, and it requires users to determine and summarize, which is called “automatic grouping” for short.

In machine learning algorithms, it is often necessary to extract features for each sample so that each sample can be represented using a n-dimensional feature vector:

xᵢ=(xᵢ₁,xᵢ₂, . . . ,xᵢₙ). (2)

All samples constitute a sampling dataset X={x₁,x₂, . . . ,xₘ}, which contains m samples. The clustering task is to divide the dataset X into k different clusters {Cₗ|l=1,2, . . . , Cₖ}, which meets a condition of Cₗ∩cᵢ=Ø when l≠l′. Each sample x₁ corresponds to a cluster label λⱼ, indicating that the sample belongs to a cluster xᵢ∈λ_{c}_{ⱼ}. As can be seen, clustering is intended to generate a corresponding cluster label vector λ=(λ₁,λ₂, . . . ,λₘ) for the dataset X={x₁,x₂, . . . ,xₘ}. The K-Means algorithm is the most basic clustering algorithm. For a given dataset X={x₁,x₂, . . . ,xₘ}, the K-Means algorithm uses a method of minimizing a mean square error for the dividing of clusters C={C₁, C₂, . . . ,Cₖ}:

E=Σⱼ₌₁^{k}Σ_{x∈C}_{ⱼ}∥x−μⱼ∥₂². (3)

where

$${μ}_{j} = \frac{1}{\vert {C}_{j} \vert} {\sum }_{x ∈ {C}_{j}} x$$

denotes a mean vector of the cluster Cⱼ, i.e. a center position. Thus, the above equation can be expressed as a closeness of sample points in each cluster. The higher the closeness is, the higher a similarity of the samples within the cluster is. Cluster analysis is based on similarity. Modes in the same cluster is more similar than those in different clusters.

In the present example, the above “a plurality of second feature extraction results” corresponds to the above “sampling dataset X”. Specifically, after calculating the plurality of second feature extraction results, the plurality of second feature extraction results may be stored in a form of a matrix, where each column in the matrix is a feature and each row is a sample. In practice, the matrix for features may be normalized using a normalization method in a machine learning framework, such as sklearn, and then trained. After a large number of “second feature extraction results” are trained, a plurality of clusters are obtained by using the classification model, and then semantic labels are added to the clusters through features of the clusters to set subsequent operations. The clustering algorithm is used in order to avoid evaluating a classification accuracy. For an automatic clustering result, it is only required to manually add a semantics to each cluster and a subsequent adjusting operation is performed. This has the following advantages: firstly, manual labeling for a large amount of data is avoided; and secondly, by the clustering algorithm, it is possible to automatically find an inherent distribution.

Of course, other clustering algorithms may be selected to construct the classification model. During the training process, indexes (such as a Silhouette Score and the like) may be used to evaluate the clustering, which is not limited herein.

The above example essentially discloses a “training” stage of the model, in which a plurality of control pulses are first generated using some sampling parameters, and are respectively input to the quantum chip to obtain a sampled dataset for analyzing, to finally obtain an unlabelled training dataset (i.e., the second feature extraction results); then a specific clustering algorithm (e.g., K-Means algorithm, etc.) is used to perform clustering and learning; and after obtaining different clusters, semantic labels are assigned to the clusters according to properties of the clusters to characterize properties of experimental results (the results are good or bad, the reasons leading to bad results, etc.). The clustering algorithm is used to classify types of experimental sampled data. On the one hand, complicated data labeling work is avoided; on the other hand, the inherent distribution structure of the data can be obtained, such that an efficiency of model “training” is improved, and a use effect of the trained sampling quality classification model is guaranteed.

In an example, in step S503, training the clustering model using the plurality of second feature extraction results to obtain the sampling quality classification model may include: inputting the plurality of second feature extraction results corresponding to the plurality of second output signals into the clustering model to obtain an initial classification result; and adjusting model parameters of the clustering model according to a difference between the initial classification result and a preset classification result to obtain the sampling quality classification model.

Specifically, in actual operations, since the model training is performed using the “unlabeled” data, it is necessary to determine whether the model training is completed in the following manner.

First, determination is performed by the number of training samples. In general, the more the training samples, the better the clustering result. Therefore, a sample number threshold needs to be set. If sampling is performed on a certain output signal according to a certain sampling parameter and a set of samples are obtained, then the training is considered to be completed in a case that the number of samples in the set exceeds a preset threshold.

Second, the determination is performed by a difference between the clustering result and a preset classification result. Since labelling is not performed on each sample during the training, that is, it is not known what the preset classification result should be for each sample, then after training a large number of samples, it is determined whether the clustering result already contains all the possibilities of preset classifications. For example, the preset classifications include a qualified classification and an unqualified classification, and the unqualified classification specifically includes a small sampling interval, a large sampling interval, undersamping points, oversampling, and the like.

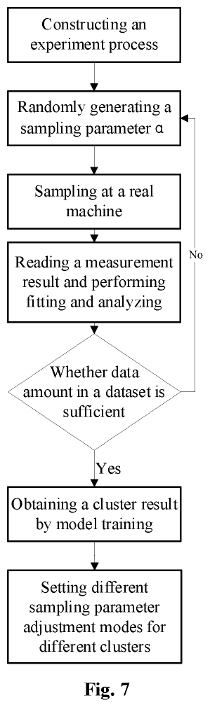

According to a current training result, the model divides the sampling quality result of the output signal into six clusters according to the input sampled data, as shown in FIG. 6. It can be seen that the cluster 0 represents the oversampling, the cluster 1 represents the large sampling interval, the cluster 2 represents the undersampling, the cluster 3 represents the small sampling interval, the cluster 4 represents the sampling quality result being the qualified classification, and the cluster 5 is also the large sampling interval. It can be seen that the clustering result covers all the preset classification results, and the model training can be determined to be completed. If it is determined that the model needs to continue training, then parameters thereof are adjusted automatically by a machine or manually.

With the above example, it is possible to accurately determine whether the accuracy of the classification model meets requirements without labeling, thereby stopping training in time and improving an overall efficiency of model training.

In an example, the preset classification result includes a first classification result and a second classification result, and the above solution further includes: presetting a plurality of first classification results and the second classification results.

Embodiments of the first classification result and the second classification result can be referred to relevant descriptions in the method for determining the signal sampling quality, and will not be repeated here.

In an example, if the training samples is divided into six clusters as shown in FIG. 6 after the model is trained, a corresponding sampling parameter adjustment mode for each of the six clusters needs to be set, as shown in Table 1.

| Cluster | | |
|---|---|---|
| number | Classification | Subsequent operation |
| 0 | oversample | end and output a required calibration result |
| 1 | large sampling | a scan range maximum A_{iS} is modified to 0.5 |
| | interval | times of a previous scan range maximum |
| 2 | undersample | a number of scanning sampling points S is |
| | | modified to twice as much as a previous |
| | | number of scanning sampling points |
| 3 | small sampling | the scan range maximum A_{iS} is modified to 2 |
| | interval | times as much as a previous scan range |
| | | maximum |
| 4 | qualified | end and output the required calibration result |
| 5 | large sampling | the scan range maximum A_{iS} is modified to 0.5 |
| | interval | times of a previous scan range maximum |

With the above-described solution, calibration steps requiring manual repeated adjusting can be performed automatically by using the model to predict a classification current sampling data, and then to automatically obtain and execute a subsequent operation instruction, thus realizing automatic guidance.

An application example of the method of determining the signal sampling quality and the method for training the model based on the present embodiment will be described below.

The solution of the present disclosure can be divided into two stages of “training” and “applying”. The training phase refers to training the clustering model using training samples and providing semantic labels and subsequent operations to the clusters. The applying phase refers to evaluating the sampling data using the trained model and performing appropriate operations. Steps of the “training” phase are shown in FIG. 7, which is accomplished using an unsupervised learning algorithm, summarized as follows:

1. designing a calibration experiment process, inputting a required sampling parameter type and an adjustable range of hardware;

2. generating the sampling parameter a1 (corresponding to the second sampling parameter in the above) randomly within the adjustable range;

3. performing an experiment and sampling to obtain a measurement result d1 (corresponding to the second sampling data in the above) (it should be noted that the measurement result d1 substantially includes a plurality of sets of sampling data);

4. fitting and analyzing the result to obtain training data x1 (corresponding to the second feature extraction result in the above) after feature extraction;

5. determining whether a number of current data items is sufficient, if not, returning to the step 2, otherwise, entering the step 6;

6. performing model training by applying a clustering algorithm to obtain a model M (corresponding to the above sampling quality classification model), adding a semantic label, and setting a subsequent operation (the operation may be specifically a sampling parameter adjustment mode) to each cluster therein.

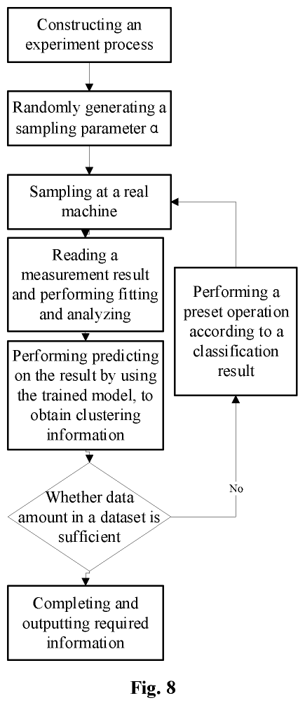

7. after completing the training, using the model M to implement a fully automated “applying”, a process of which is shown in FIG. 8, where the steps of the process are summarized as follows:

1. designing a calibration experiment process, inputting a required sampling parameter type and an adjustable range of hardware;

2. generating a sampling parameter a2 (corresponding to the first sampling parameter above) randomly within the adjustable range;

3. performing an experiment and sampling to obtain a measurement result d2 (corresponding to the first sampled data in the above);

4. fitting and analyzing the result to obtain training data x2 (corresponding to the first feature extraction result in the above) after feature extraction;

5. performing classifying using the clustering model M obtained in the “training” stage;

6. performing an operation according to a classification result, if the classification being undesirable, proceeding to step 7, otherwise proceeding to step 8;

7. adjusting the sampling parameter using the parameter adjustment mode set in the “training” phase, and repeating the step 3;

8. completing the training of the sampled data, and outputting essential information (such as sampling and fitting results).

It should be noted that the principles of acquiring above “the first sampling parameter” and above “the second sampling parameter” are identical, and “first” and “second” are used to mainly distinguish a usage scenario. The remaining terms of “the first sampled data”, “the second sampled data”, and “the first feature extraction result” and “the second feature extraction result” are similar, and will not be repeated herein.

In the above disclosed solution, unsupervised learning is performed using unlabelled training data based on a clustering model, so that the inherent distribution structure among the data can be found, while the complicated work of data labeling is omitted. Meanwhile, since the sampled data are randomly selected, with the increase of the amount of data, more situations in the sampling parameter space can be covered uniformly, a sufficient coverage of the training data is guaranteed, and finally a sampling quality evaluation model which can be used for “abduction reasoning” is trained and used.

A processing flow for training sample acquisition according to an embodiment of the present disclosure includes the following details.

Taking a Rabi oscillation experiment as an example, it is shown how to find a sampling parameter (the sampling parameter specifically includes a scanning interval of a Gaussian pulse amplitude and the number of sampling points). First, a program constructs an experimental pulse through a preset experimental flow and a preset sampling parameter, generates a control signal and inputs the control signal into a quantum chip located in a refrigerator, and then receives and analyzes a return signal through a reading device to obtain a final reading result. In the Rabi experiment, the control pulse is often constructed using a Gaussian function, which is specifically shown below:

A(t)=A·exp[((t−τ)/σ)²], (4)

where A is the maximum amplitude, τ is a center position of the pulse, and U is a standard deviation. One Rabi experiment can produce one training sample. For example, the i-th training sample is composed of S samplings with different amplitudes (scan amplitudes):

Aᵢ=(Aᵢ₁,Aᵢ₂, . . . ,Aᵢⱼ, . . . ,A_{iS}), (5)

where Aᵢ₁, . . . , A_{iS} is an arithmetic progression, Aᵢ₁ and A_{iS} are the minimum and maximum of the amplitude (usually Aᵢ₁=0), respectively, forming a Gaussian pulse amplitude scanning interval, where the subscript i denotes a serial number of the training sample and the subscript j denotes a serial number of the Gaussian pulse amplitude. In this example, “sampling parameter” refers to the Gaussian pulse amplitude scanning interval and the number of sampling points S. After the sampling is completed, the “experimental sampling sample” Dᵢ contains S points, and then m groups of different random sampling parameters are randomly selected for respectively sampling to obtain m groups of training samples to form a final sampling dataset D={D₁,D₂, . . . , Dₘ} (equivalent to the second sampling data in the above). The populations at different energy levels of a quantum state are usually used as measurement results for fitting and feature extraction.

A processing flow for applying the data feature extraction and model training according to an embodiment of the present disclosure includes the following details.

First, the sampled data Dᵢ is fitted, and the training sample Xᵢ (equivalent to the second feature extraction result in the above) is constructed by combining the sampled data Dᵢ and the “fitting sampling sample” Eᵢ obtained through a fitting result.

For the i-th sample Dᵢ, the fitting is performed first using the equation mentioned above:

$$f ( x ) = \frac{a}{2} cos ( bx + c ) + d . \qquad ( 1 )$$

a fitting result βᵢ*={aᵢ*,bᵢ*,cᵢ*,dᵢ*} is obtained after fitting, where correspond to fitting parameters in the above equation, thus:

βᵢ*=fit(f(·),Aᵢ,Dᵢ,βᵢ⁰), (6)

where βᵢ⁰ is an initial parameter of the fitting and Aᵢ is a Gaussian pulse amplitude sequence. A “fitting sampling sample” Eᵢ is then derived based on the sampled data Dᵢ using the fitted βᵢ* and Aᵢ. In the present example, a feature is constructed based on a difference between original data and the fitting result Eᵢ, mainly including a plurality of features, such as “a fitting function”, “a co-correlation coefficient”, “a population distribution”, “an oscillation period”, and the like, which will collectively be used as the training sample Xᵢ of a current sample, Xᵢ meeting the following equation:

Xᵢ=[FitError(D,E), Cov(D,E),MaxPopE(D,E), . . . ]^{T} (7)

Detailed calculation of FitError(D, E), Cov(D, E), and the like is described in detail below:

(1) The Fitting Error and the Co-Correlation Coefficient

A fitting error of the i-th training sample Dᵢ is calculated using the following equation:

FitErrorᵢ(Dᵢ,Eᵢ)=Σⱼ₌₁^{S}|Eᵢⱼ−Dᵢⱼ|, (8)

where S=|Dᵢ| represents the sample. The co-correlation coefficient can be expressed as follows:

$${Cov}_{i} ( {D}_{i} , {E}_{i} ) = \frac{{\sum }_{j = 1}^{S} ( {E}_{ij} - {\overline{E}}_{ij} ) ( {D}_{ij} - {\overline{D}}_{ij} )}{S - 1} , \qquad ( 9 )$$

These two features can be used to represent a correlation between the fitting result and the original data. In general, the smaller the noise and the better the fitting, the greater the correlation, i.e., the smaller the fit error, the greater the covariance.

(2) Population-Related Features

Such features are a maximum, a minimum and a median value in the original data:

MaxPopEᵢ(Eᵢ)=max Eᵢ, (10)

MinPopEᵢ(Eᵢ)=min Eᵢ, (11)

MedianPopEᵢ(Eᵢ)=[MaxPopᵢ(Eᵢ)+MinPopᵢ(Eᵢ)]/2, (12)

A method for obtaining population features MaxPopDᵢ(Dᵢ), MinPopDᵢ(Dᵢ), MedianPopDᵢ(Dᵢ) of the fitting data is similar and will not be repeated herein.

(3) Features Related to the Oscillation Period

The first one is an autocorrelation function of the original data, which can be used to calculate periodicity of data. An advantage of this method over the Fourier transform is that: in a case of a small data period, a result is more accurate. The autocorrelation function corresponds to a convolution of a sequence with itself:

R_{D}_{ᵢ}_{D}_{ᵢ}(0)=Dᵢ*Dᵢ=Σⱼ₌₀ⁿDᵢⱼDᵢ₍₋ⱼ), (13)

The period ACPeriodᵢ(Dᵢ) equals a position of the first peak in the sequence obtained by the autocorrelation function. In addition, the period FitPeriodᵢ(Eᵢ)=2π/bᵢ* can be obtained according to the fitting result, where bᵢ* is the fitted period. According to the period, an important feature can be obtained, i.e. the number of sampling points per period:

$${SamplesPerPeriod}_{i} ( {D}_{i} ) = \frac{S}{{ACPeriod}_{i} ( {D}_{i} )} . \qquad ( 14 )$$

So far, the feature extraction method has been introduced completely. Next, model training is performed using the K-means algorithm. Prior to training, the above features are computed and stored in a feature matrix where each column is a feature and each row is a sample. The feature matrix need to be normalized using existing technologies and subsequently training is performed. As shown in FIG. 6, all data are divided into 6 clusters, and semantic labels are added to the clusters by observing the features of the clusters, and subsequent operations are set.

At this point, the training phase is completed and the trained model is referred to as M_{Rabi} Next, a subsequent operation will be performed using the above model.

After the model training is completed, the applying phase is entered. That is, in a real experimental environment, predicting a classification of the collected data by using the trained model M_{Rabi} to obtain a corresponding classification. Then, a prediction parameter (specifically, the number of sampling points and the Gaussian pulse amplitude) is adjusted according to a label of the classification and a preset operation, and re-perform the above-described process until the classification result indicates a classification of “a qualified sampling quality (desirable)”, specific steps of the applying phase are shown in FIG. 8.

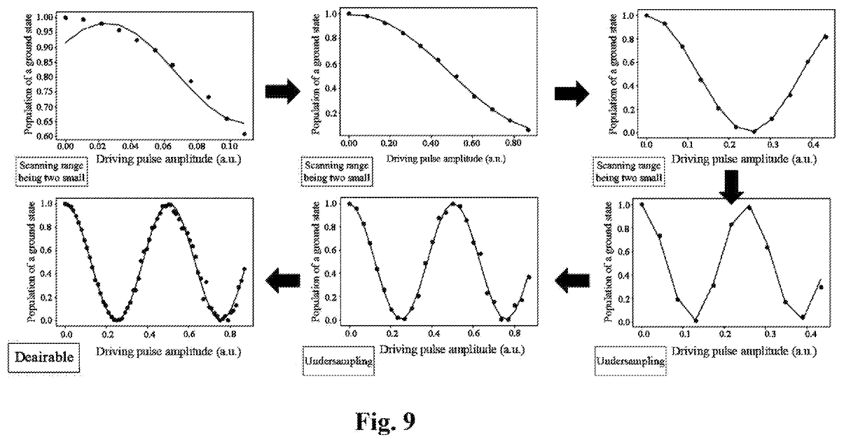

FIG. 9 shows a diagram in which sampling of an output signal is continuously adjusted (corrected) to obtain a result of “a qualified sampling quality qualified (desirable)”. It can be seen that, according to directions of arrows, through multiple adjustments of the scan parameter, a better scan parameter range is finally obtained, and a better fitting result is obtained by the fitting function, thereby obtaining an experimental parameters (e.g., a if pulse amplitude) required for calibration.

In actual operations, the solution of the present disclosure is compared with a random sampling method in the existing technologies, where both solutions aim at achieving the same fitting accuracy and iteration steps required to achieve the target fitting accuracy are compared. An initial value of a maximum of the Gaussian pulse amplitude scan is randomly selected within a range of [0, 10]. A comparison result between the two solutions are shown in Table 2, where the “error” is calculated from equation (7) above:

TABLE 2
Comparison Result Of The Solution Of The Present
Disclosure With The Random Sampling Method

| | Number of experiments | | | | | |
|---|---|---|---|---|---|---|
| | 1 | 2 | 3 | 4 | 5 | 6 |
| number of | 2 steps | 6 steps | 3 steps | 2 steps | 2 steps | 4 steps |
| iterations/ | 0.0104 | 0.0127 | 0.0324 | 0.0151 | 0.0137 | 0.0112 |
| Error of | | | | | | |
| the present | | | | | | |
| solution | | | | | | |
| Number of | 12 steps | 9 steps | 15 steps | 8 steps | 9 steps | 7 steps |
| iterations/error | 0.0123 | 0.0137 | 0.0144 | 0.0110 | 0.0200 | 0.0124 |
| required for | | | | | | |
| random | | | | | | |
| sampling | | | | | | |

It is apparent that the number of iterations for finding a suitable sampling parameter can be greatly reduced using the disclosed solution.

Main innovative effects of the above solution are as follows.

First, the signal quality calibration method of the present embodiment performs automatic calibration based on the abduction reasoning. That is, during the calibration, if the sampling result is not desirable, then by using a machine learning algorithm and according to a sampling parameter adjustment mode corresponding to the first preset classification result, the sampling experimental parameter is adjusted. Since the adjustment modes of the sampling parameter are determined based on failure reasons corresponding to the classification results, the automatic process can be made more interpretable and can be processed in non-ideal cases, so that more complete automation (a more accurate initial sampling parameter is not needed) is achieved, and a final success rate is also improved.

Second, an initial network model in this embodiment may be a clustering model. That is, a clustering algorithm may be used for model training, including: the clustering algorithm is used to divide types of experimental sampled data. On the one hand, cumbersome data labeling work is avoided, and on the other hand, the inherent distribution structure of these data can be found.

Third, a feature is extracted using the difference between the fitting result and the original data. In this solution, the difference between the original sampled data and the fitting result is used to construct the feature, because the fitting function is often given by known theoretical knowledge, which enables the model training process to be theoretically guided, thereby reducing a training difficulty.

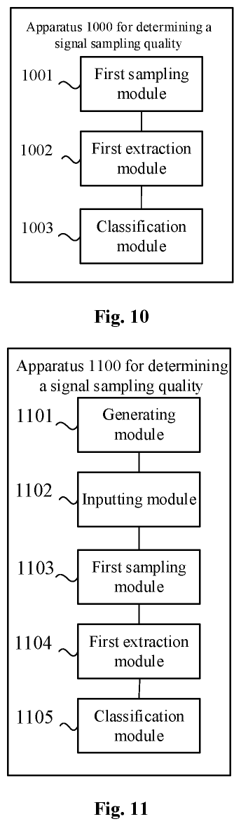

As shown in FIG. 10, an embodiment of the present disclosure provides a apparatus for determining a signal sampling quality 1000, which includes:

a first sampling module 1001, configured to sample a first output signal of a quantum chip based on a first sampling parameter to obtain first sampled data;

a first extraction module 1002, configured to perform feature extraction on the first sampled data to obtain a first feature extraction result; and

a classification module 1003, configured to cluster the first feature extraction result to determine a sampling quality classification result.

In an example, performing feature extraction on the first sampled data to obtain a first feature extraction result, includes:

generating a fitting function according to a signal generation function and/or a structure of the quantum chip;

fitting the first sampled data using the fitting function to obtain a fitting curve; and

obtaining the first feature extraction result according to the first sampled data and the fitting curve.

As shown in FIG. 11, an embodiment of the present disclosure provides yet another apparatus 1100 for determining a signal sampling quality, the apparatus including:

a generating module 1101, configured to generate a control signal based on an experimental threshold and the signal generation function;

an inputting module 1102, configured to use the control signal as an input to the quantum chip to obtain the first output signal;

a first sampling module 1103, configured to sample the first output signal of the quantum chip based on the first sampling parameter to obtain first sampled data;

a first extraction module 1104, configured to perform feature extraction on the first sampled data to obtain a first feature extraction result; and

a classification module 1105, configured to cluster the first feature extraction result to determine a sampling quality classification result.

In an example, the first sampled data includes populations of a quantum state at different energy levels, the first sampling parameter includes a scanning interval and a number of sample times, and the first sampling module is configured to:

sampling the first output signal according to the number of sampling times in the scanning interval to obtain the populations of the quantum state at different energy levels.

In an example, the first feature extraction result includes at least one of a fitting error, a co-correlation coefficient, a sampled data feature, an autocorrelation function, and a periodic sample point feature.

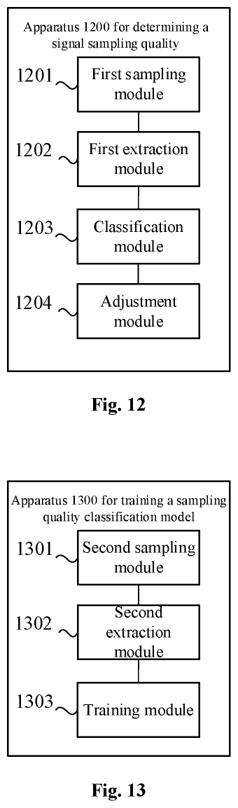

As shown in FIG. 12, the embodiment of the present disclosure provides another apparatus 1200 for determining a signal sampling quality, in which a sampling quality classification result includes a first classification result not meeting a preset quality standard and a second classification result meeting the preset quality standard, the apparatus including:

a first sampling module 1201, configured to sample a first output signal of a quantum chip based on a first sampling parameter to obtain first sampled data;

a first extraction module 1202, configured to perform feature extraction on the first sampled data to obtain a first feature extraction result;

a classification module 1203, configured to input the first feature extraction result into a sampling quality classification model to obtain a sampling quality classification result.

The adjustment module 1204, configured to adjust the first sampling parameter according to, in a case that the sampling quality classification result is the first classification result, adjust the first sampling parameter according to a sampling parameter adjustment mode corresponding to the first classification result.

The apparatus as disclosed in any of the above embodiments, the classification module is further configured to:

input the first feature extraction result into a sampling quality classification model to obtain the sampling quality classification result, wherein the sampling quality classification model is obtained based on training of a clustering model.

As shown in FIG. 13, an embodiment of the present disclosure provides a apparatus 1300 for training a sampling quality classification model, the apparatus includes:

a second sampling module 1301, configured to sampling a plurality of second output signals of a quantum chip respectively based on a plurality of second sampling parameters to obtain a plurality of sets of second sampled data;

a second extraction module 1302, configured to perform feature extraction on each of the plurality of sets of second sampled data to obtain a plurality of second feature extraction results, each corresponding to a set of second sampled data; and

a training module 1303, configured to train a clustering model using the plurality of second feature extraction results to obtain a sampling quality classification model, wherein the sampling quality classification model is configured to determine a sampling quality classification result.

The apparatus for training a sampling quality classification model as disclosed in any of the above embodiments, the training module is configured to:

inputting the plurality of second feature extraction results corresponding to the plurality of second output signals into the clustering model to obtain an initial classification result; and

adjusting model parameters of the clustering model according to a difference between the initial classification result and a preset classification result to obtain the sampling quality classification model.

The apparatus for training a sampling quality classification model as disclosed in any one of the above embodiments, the preset classification result includes a first classification result and a second classification result, and the training module is further configured to:

presetting a plurality of first classification results and the second classification result; and

presetting a plurality of sampling parameter adjustment modes respectively corresponding to the first classification results.

The functions of each module in each apparatus of the embodiment of the present disclosure can be referred to the corresponding description in the above method, and will not be repeated herein.

In the technical solution of the present disclosure, the acquisition, storage and application of the user personal information involved are in compliance with relevant laws and regulations, and do not violate public order and good customs.

According to embodiments of the present disclosure, the present disclosure also provides an electronic device, a readable storage medium, and a computer program product.

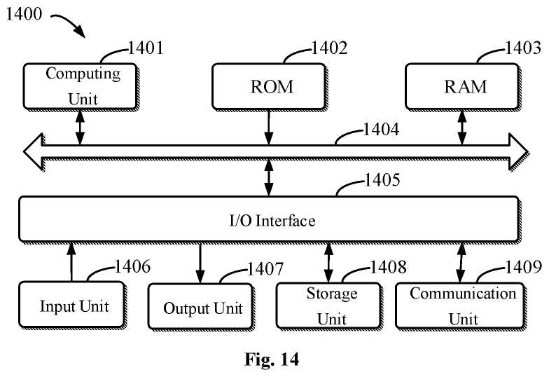

FIG. 14 illustrates a schematic block diagram of an example electronic device 1400 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 14, the device 1400 includes a computing unit 1401, which may perform various appropriate actions and processing, based on a computer program stored in a read-only memory (ROM) 1402 or a computer program loaded from a storage unit 1408 into a random access memory (RAM) 1403. In the RAM 1403, various programs and data required for the operation of the device 1400 may also be stored. The computing unit 1401, the ROM 1402, and the RAM 1403 are connected to each other through a bus 1404. An input/output (I/O) interface 1405 is also connected to the bus 1404.

A plurality of parts in the device 1400 are connected to the I/O interface 1405, including: an input unit 1406, for example, a keyboard and a mouse; an output unit 1407, for example, various types of displays and speakers; the storage unit 1408, for example, a disk and an optical disk; and a communication unit 1409, for example, a network card, a modem, or a wireless communication transceiver. The communication unit 1409 allows the device 1400 to exchange information/data with other devices over a computer network such as the Internet and/or various telecommunication networks.

The computing unit 1401 may be various general-purpose and/or dedicated processing components having processing and computing capabilities. Some examples of the computing unit 1401 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 1401 performs the various methods and processes described above, such as a method for determining a signal sampling quality. For example, in some embodiments, the method for determining a signal sampling quality may be implemented as a computer software program, which is tangibly included in a machine readable medium, such as the storage unit 1408. In some embodiments, part or all of the computer program may be loaded and/or installed on the device 1400 via the ROM 1402 and/or the communication unit 1409. When the computer program is loaded into the RAM 1403 and executed by the computing unit 1401, one or more steps of the method for determining a signal sampling quality described above may be performed. Alternatively, in other embodiments, the computing unit 1401 may be configured to perform the method for determining a signal sampling quality by any other appropriate means (for example, by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or a combination thereof. The various implementations may include: an implementation in one or more computer programs that are executable and/or interpretable on a programmable system including at least one programmable processor, which may be a special-purpose or general-purpose programmable processor, and may receive data and instructions from, and transmit data and instructions to, a storage system, at least one input apparatus, and at least one output device.

Program codes for implementing the method of the present disclosure may be compiled using any combination of one or more programming languages. The program codes may be provided to a processor or controller of a general-purpose computer, a special-purpose computer, or other programmable apparatuses for processing vehicle-road collaboration information, such that the program codes, when executed by the processor or controller, cause the functions/operations specified in the flow charts and/or block diagrams to be implemented. The program codes may be completely executed on a machine, partially executed on a machine, executed as a separate software package on a machine and partially executed on a remote machine, or completely executed on a remote machine or server.

In the context of the present disclosure, the machine-readable medium may be a tangible medium which may contain or store a program for use by, or used in combination with, an instruction execution system, apparatus or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, an optical storage device, a magnetic storage device, or any appropriate combination of the above.

To provide interaction with a user, the systems and technologies described herein may be implemented on a computer that is provided with: a display apparatus (e.g., a CRT (cathode ray tube) or a LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or haptic feedback); and an input may be received from the user in any form (including an acoustic input, a voice input, or a tactile input).

The systems and technologies described herein may be implemented in a computing system (e.g., as a data server) that includes a back-end component, or a computing system (e.g., an application server) that includes a middleware component, or a computing system (e.g., a user computer with a graphical user interface or a web browser through which the user can interact with an implementation of the systems and technologies described herein) that includes a front-end component, or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and usually interact via a communication network. The relationship between the client and the server arises by virtue of computer programs that run on corresponding computers and have a client-server relationship with each other. The server may be a cloud server, a distributed system server, or a server combined with a blockchain.

It should be understood that the various forms of processes shown above may be used to reorder, add, or delete steps. For example, the steps disclosed in the present disclosure may be executed in parallel, sequentially, or in different orders, as long as the desired results of the technical solutions disclosed in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method of determining a signal sampling quality, comprising:
sampling a first output signal of a quantum chip based on a first sampling parameter to obtain first sampled data;
performing feature extraction on the first sampled data to obtain a first feature extraction result; and
clustering the first feature extraction result to determine a sampling quality classification result.

2. The method according to claim 1, wherein performing feature extraction on the first sampled data to obtain the first feature extraction result, comprises:
generating a fitting function according to a signal generation function and/or a structure of the quantum chip;
fitting the first sampled data using the fitting function to obtain a fitting curve; and
obtaining the first feature extraction result according to the first sampled data and the fitting curve.

3. The method according to claim 2, further comprising:
generating a control signal based on an experimental threshold and the signal generation function; and
using the control signal as an input to the quantum chip to obtain the first output signal.

4. The method according to claim 1, wherein the first sampled data comprises populations of a quantum state at different energy levels, the first sampling parameter comprises a scanning interval and a number of sampling times, and sampling the first output signal of the quantum chip based on the first sampling parameter to obtain the first sampled data comprises:
sampling the first output signal according to the number of sampling times in the scanning interval to obtain the populations of the quantum state at different energy levels.

5. The method according to claim 1, wherein the first feature extraction result comprises at least one of a fitting error, a co-correlation coefficient, a sampled data feature, an autocorrelation function, and a periodic sample point feature.

6. The method according to claim 1, wherein the sampling quality classification result includes a first classification result not meeting a preset quality standard and a second classification result meeting the preset quality standard, the method further comprising:
in a case that the sampling quality classification result is the first classification result, adjusting the first sampling parameter according to a sampling parameter adjustment mode corresponding to the first classification result.

7. The method according to claim 1, wherein clustering the first feature extraction result to determine the sampling quality classification result, comprises:
inputting the first feature extraction result into a sampling quality classification model to obtain the sampling quality classification result, wherein the sampling quality classification model is obtained based on training of a clustering model.

8. A method for training a sampling quality classification model, comprising:
sampling a plurality of second output signals of a quantum chip respectively based on a plurality of second sampling parameters to obtain a plurality of sets of second sampled data;
performing feature extraction on each of the plurality of sets of second sampled data to obtain a plurality of second feature extraction results, each corresponding to a set of second sampled data; and
training a clustering model using the plurality of second feature extraction results to obtain a sampling quality classification model, wherein the sampling quality classification model is configured to determine a sampling quality classification result.

9. The method according to claim 8, wherein training the clustering model using the plurality of second feature extraction results to obtain the sampling quality classification model, comprises:
inputting the plurality of second feature extraction results corresponding to the plurality of second output signals into the clustering model to obtain an initial classification result; and
adjusting model parameters of the clustering model according to a difference between the initial classification result and a preset classification result to obtain the sampling quality classification model.

10. The method according to claim 9, wherein the preset classification result comprises a first classification result and a second classification result, training the clustering model using the plurality of second feature extraction results to obtain the sampling quality classification model, further comprising:
presetting a plurality of first classification results and the second classification result; and
presetting a plurality of sampling parameter adjustment modes respectively corresponding to the first classification results.

11. A apparatus for determining a signal sampling quality, comprising:
at least one processor; and
a memory storing instructions, wherein the instructions when executed by the at least one processor, cause the at least one processor to perform operations, the operations comprising:
sampling a first output signal of a quantum chip based on a first sampling parameter to obtain first sampled data;
performing feature extraction on the first sampled data to obtain a first feature extraction result; and
clustering the first feature extraction result to determine a sampling quality classification result.

12. The apparatus according to claim 11, wherein performing feature extraction on the first sampled data to obtain the first feature extraction result, comprises:
generating a fitting function according to a signal generation function and/or a structure of the quantum chip;
fitting the first sampled data using the fitting function to obtain a fitting curve; and
obtaining the first feature extraction result according to the first sampled data and the fitting curve.

13. The apparatus according to claim 12, the operations further comprising:
generating a control signal based on an experimental threshold and the signal generation function; and
using the control signal as an input to the quantum chip to obtain the first output signal.

14. The apparatus according to claim 11, wherein the first sampled data comprises populations of a quantum state at different energy levels, the first sampling parameter comprises a scanning interval and a number of sampling times, and sampling the first output signal of the quantum chip based on the first sampling parameter to obtain the first sampled data comprises:
sampling the first output signal according to the number of sampling times in the scanning interval to obtain the populations of the quantum state at different energy levels.

15. The apparatus according to claim 11, wherein the first feature extraction result comprises at least one of a fitting error, a co-correlation coefficient, a sampled data feature, an autocorrelation function, and a periodic sample point feature.

16. The apparatus according to claim 11, wherein the sampling quality classification result includes a first classification result not meeting a preset quality standard and a second classification result meeting the preset quality standard, the operations further comprising:
adjusting, in a case that the sampling quality classification result is the first classification result, the first sampling parameter according to adjust the first sampling parameter according to a sampling parameter adjustment mode corresponding to the first classification result.

17. The apparatus according to claim 11, wherein clustering the first feature extraction result to determine the sampling quality classification result, comprises:
inputting the first feature extraction result into a sampling quality classification model to obtain the sampling quality classification result, wherein the sampling quality classification model is obtained based on training of a clustering model.

18. The method according to claim 2, wherein the sampling quality classification result includes a first classification result not meeting a preset quality standard and a second classification result meeting the preset quality standard, the method further comprising:
in a case that the sampling quality classification result is the first classification result, adjusting the first sampling parameter according to a sampling parameter adjustment mode corresponding to the first classification result.

19. The method according to claim 3, wherein the sampling quality classification result includes a first classification result not meeting a preset quality standard and a second classification result meeting the preset quality standard, the method further comprising:
in a case that the sampling quality classification result is the first classification result, adjusting the first sampling parameter according to a sampling parameter adjustment mode corresponding to the first classification result.

20. The method according to claim 4, wherein the sampling quality classification result includes a first classification result not meeting a preset quality standard and a second classification result meeting the preset quality standard, the method further comprising:
in a case that the sampling quality classification result is the first classification result, adjusting the first sampling parameter according to a sampling parameter adjustment mode corresponding to the first classification result.
